(19) United States
(12) Patent Application Publication
(10) Pub. No.: US 2025/0292138 A1
(43) Pub. Date: Sep. 18, 2025

(54) ORCHESTRATING QUBO-BASED ML MODELS ON MULTIPLE ANNEALERS TO MITIGATE OVERFITTING

(71) Applicant: Dell Products L.P., Round Rock, TX (US)

(72) Inventors: Ítalo Gomes Santana, Rio de Janeiro (BR); Miguel Paredes Quiñones, Campinas (BR)

(21) Appl. No.: 18/605,666

(22) Filed: Mar. 14, 2024

(51) Int. Cl. G06N 10/60

(52) U.S. Cl. CPC G06N 10/60

(57) ABSTRACT

One example method includes creating a training data set comprising historical data regarding performance of respective instances of a machine learning (ML) model deployed at edge devices, creating a pool of ML models by sampling solutions from one or more quantum annealers, and each ML model in the pool comprises a respective one of the solutions, selecting data from the training data set, using the data selected from the training data set to test the ML models in the pool with respect to a specified measure of interest, and deploying respective instances of a best-performing ML model from the pool to each of the edge devices.

### FIELD OF THE INVENTION

Embodiments of the present invention generally relate to quantum machine learning. More particularly, at least some embodiments of the invention relate to systems, hardware, software, computer-readable media, and methods, for training quantum machine learning models for deployment in edge environments.

### BACKGROUND

Diversity in machine learning models is required in heterogeneous environments as input data may change at each device, making necessary different models exposed to the same training set. One particular problem with some conventional approaches is overfitting. That is, while the deployed models may perform well in terms of the predictions that they make in connection with training data, the models may generate insufficiently accurate predictions when considering new data. Thus, the predictive power of such models may be poor.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a relation between optimization problems and corresponding physical systems.

FIG. 2 discloses aspects of an example of a quantum annealing workflow.

FIG. 3 discloses an illustration of the embedding problem.

FIG. 4 discloses a comparison of simulated annealing and quantum annealing.

FIG. 5 discloses an example architecture according to an embodiment.

FIG. 6 discloses an example method according to an embodiment.

FIG. 7 discloses aspects of an example embodiment of a computing entity, which may comprise classical and/or quantum components, including annealers, configured and operable to perform part, or all, of any of the disclosed methods, processes, and operations.

### DETAILED DESCRIPTION OF SOME EXAMPLE EMBODIMENTS

Embodiments of the present invention generally relate to quantum machine learning. More particularly, at least some embodiments of the invention relate to systems, hardware, software, computer-readable media, and methods, for training quantum machine learning models for deployment in edge environments.

One example embodiment comprises a method that orchestrates QUBO-based ML (machine learning) models, which may be referred to herein simply as ‘models,’ on multiple annealers to mitigate overfitting. As used herein, QUBO refers to a ‘quadratic unconstrained binary optimization’ problem, or simply ‘QUBO.’ One example embodiment of the method, which may be performed in whole or in part by an orchestrator, comprises: determining, based on historical data, a representative training set D based on historical data; obtaining a pool P of ML models by sampling solutions on a QA (quantum annealer); for each edge device eᵢ, selecting enough data collected on that edge device and tested the data on a measure of interest, such as accuracy, of all models in P; creating a list of models LMᵢ ordered by this measure; and, deploying the best model, as determined by its measure of interest performance, into eᵢ.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that overfitting may be reduced, or avoided, in models deployed to edge devices. In an embodiment, quantum machine learning (QML) may be used to train QML models for deployment in edge environments. In an embodiment, a pool of possible trained models may be generated so as to broaden the range of potential solutions, that is, trained QMLs, that may be deployed to an edge environment. Various other advantages of one or more example embodiments will be apparent from this disclosure.

### A. Context for an Example Embodiment

The following is a discussion of aspects of an example context for various embodiments of the invention. This discussion is not intended to limit the scope of the invention, or the applicability of the embodiments, in any way.

### A.1 QUBO Optimization Problems

A QUBO is a type of combinatorial optimization problem that enables many real-world problems to be encoded in the following format:

$$H ( x ) = {\sum }_{i < j} {q}_{i , j} {x}_{i} {x}_{j} + {\sum }_{i} {q}_{i} {x}_{i}^{2} = {x}^{T} Qx$$

Where x∈{0,1}ⁿ.

### A.2 Quantum Annealing

Quantum Annealing (QA) tries to interpolate between a static problem-independent Hamiltonian for which the ground state can be efficiently prepared, and a final Hamiltonian whose ground state yields the desired answer. The QA system then linearly interpolates between H₀ and H_{f} (H_{f}=Q).

$$H ( t ) = α ( t ) {H}_{0} + β ( t ) {H}_{f}$$

Where: H_{f} is the Hamiltonian of the problem to be solved.

This system represented by H(t) evolves following the time-dependent Schrodinger equation. The system is manipulated in the manner of creating a quantum tunneling effect that makes that the system stay closer to the ground state.

### A.3 Quantum Annealing Intuition

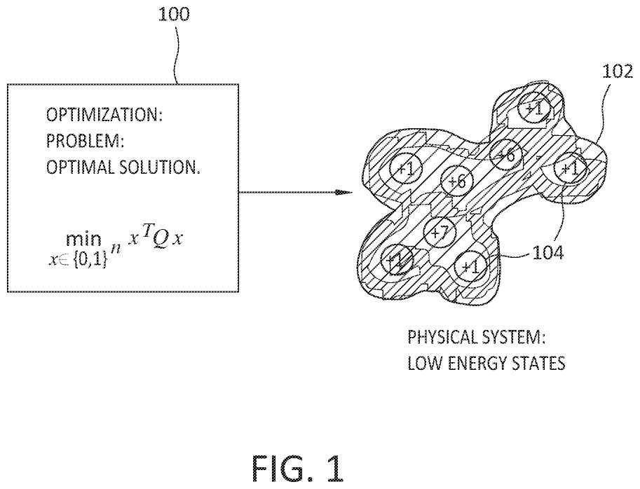

With reference briefly to FIG. 1, a solution to an optimization problem 100, such as a QUBO for example, may be thought of as being analogous to, or equating in some way to, a physical system 102. More specifically, the physical system 102 may have a variety of different low energy states 104, which may be referred to as local minima, each of which may comprise or corresponds to a respective solution to the optimization problem 100. The lowest energy state 104 may correspond to the optimal solution to the optimization problem 100.

### A.4 Example Quantum Annealing Workflow

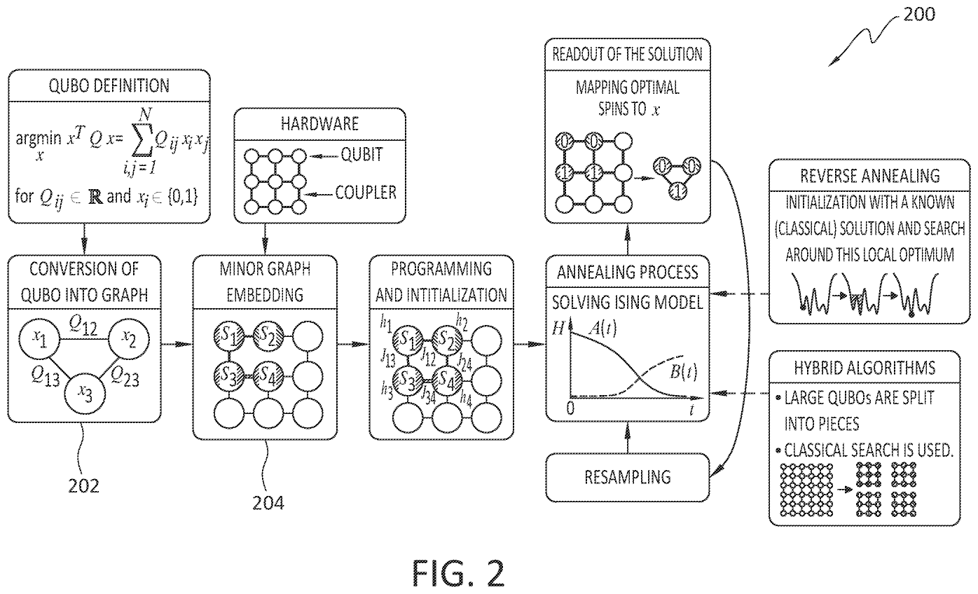

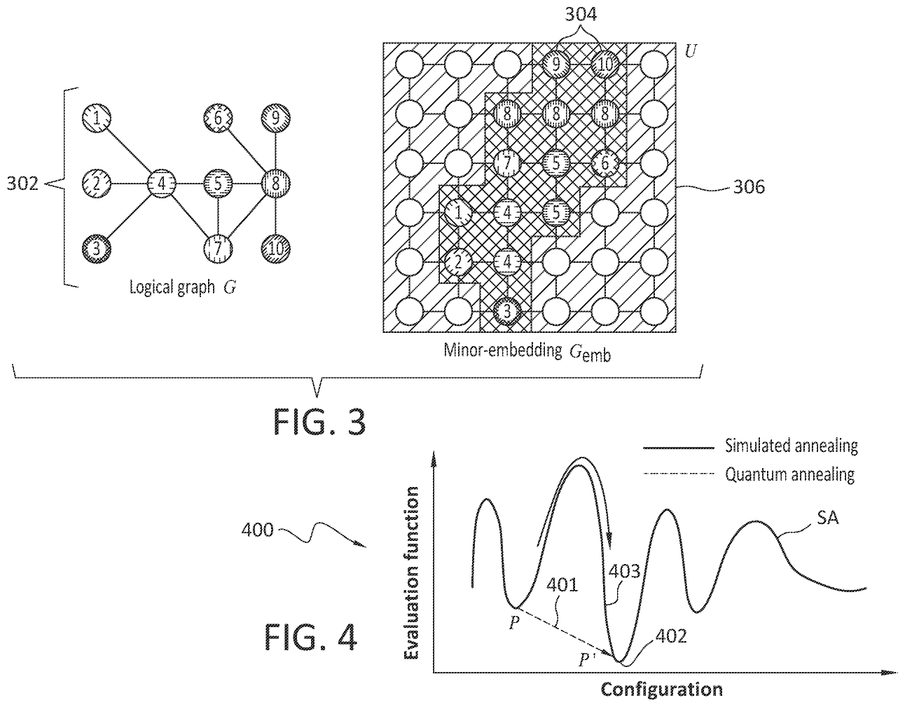

FIG. 2 discloses an example quantum annealing workflow 200. A conversion 202 of a QUBO into a graph may necessitate a graph embedding process 204 which may implicate a minor embedding problem, as disclosed in the example of FIG. 3.

### A.5 the Minor Embedding Problem

With reference now to FIG. 3, in order to solve combinatorial optimization problems such as QUBOs, it is necessary to map graph nodes 302, such as may be obtained at 202 in the example of FIG. 2, to the qubits 304 implemented in the hardware 306. In practice, heuristics may be used for this mapping. However, weak embeddings can drastically reduce the number of qubits in the hardware that are available for computation, which in turn may prevent the resolution of larger problem instances.

### A.6 Other Annealers

Simulated quantum annealing (SQA) refers to computational techniques used to simulate the environment of QA. SQA may be performed using classical computing, see, for example, https://tutorial.openjij.org/build/html/en/001-Introduction.html (OpenJiJ), classical accelerators as in the NEC vector annealing approach, or by creating specialized hardware to simulate the behavior of QA, as in the case of the Fujitsu hardware.

Simulated Annealing (SA) is a metaheuristic that resembles the annealing process on metallurgy where a QUBO can be encoded on the process of controlled cooling of a metal. SA can provide good solutions for a large range of problems but there is strong evidence that QA can find the global minimum, that is, solutions, of some problems exponentially more quickly than SA. For example, in the graph 400 in FIG. 4, it can be seen that the QA process reaches the global minimum 402 much more quickly than does the SA approach 403.

### B. Detailed Discussion of Aspects of an Example Embodiment

### B.1 Introduction

Training machine learning models in quantum hardware has become intensively explored in the literature, making Quantum Machine Learning (QML) a rapidly growing field of research. One category of quantum computing is employing adiabatic quantum computing whose implementation in specialized hardware is called quantum annealers. These annealers are usually used to heuristically solve optimization problems in Quadratic Unconstrained Binary Optimization (QUBO) format, which consists of mapping the optimization problem into variables that represents the qubits states in such annealers.

Since training machine learning models, such as neural networks, and K-means, for example, involves solving a series of optimization problems, leveraging quantum annealers for use in the machine learning field has become a practical topic of exploration. For example, Binary Neural Networks (BNNs) are powerful machine learning models that are suitable in resource constrained devices, such as edge devices for example. These networks use weights, biases, or activations limited to binary values, usually in the form {−1,1}, to perform resource efficient operations in their training and testing phases.

In an embodiment, QML is employed in edge environments to provide a way of training QML models for edge environments. More specifically, an embodiment may use the sampling feature present in quantum annealers to generate a diverse pool of heuristic solutions, that is, trained models, by optimizing the QUBO problem related to a considered ML model. With a large pool of solutions, an embodiment may check the most suitable solution, or model, for each edge device not only at first glance, but may also monitor the performance of each model over time, and replacing the model when needed, such as when performance degradations such as data drift, or overfitting/underfitting, are observed, and desired to be mitigated For cases where models perform badly in a majority of the edge devices, a simple re-run of the pipeline on an updated training dataset may be performed to improve model performance at the edges.

One embodiment may be implemented, and employed, as an ensemble-like classifier. In this embodiment, each ML model represents a weak classifier, and the output of the ensemble considers a combination of the outputs of all the weak classifiers.

### B.2 Aspects of an Example Embodiment

An embodiment may operate to maintain a pool of surrogate models and thus avoiding unnecessary model retraining in case of performance drop, such as data or concept drift, or in situations where models are overfitted to current input data. Having surrogate models that can quickly replace existing ones is beneficial in these scenarios.

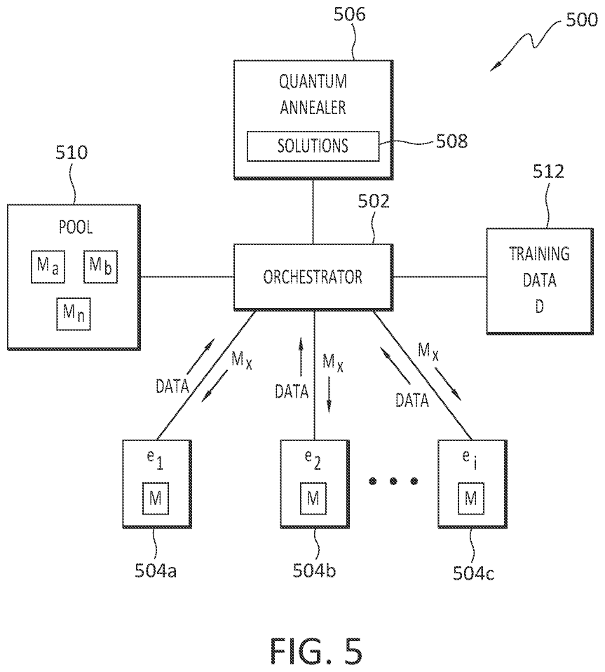

One example embodiment may be implemented in connection with the example architecture 500 disclosed in FIG. 5. The architecture 500 may comprise an orchestrator 502 that may receive data and telemetry from, and transmit models M_{X} to, one or more edge devices 504a, 504b, and 504c. The orchestrator 502 may communicate with a quantum annealer 506 that may generate and maintain one or more solutions 508 to a problem to be solved by the edge devices 504a, 504b, and 504c. In an embodiment, multiple quantum annealers 506, each having one or more solutions 508, may be employed, and solutions 508 selected from any one or more of such quantum annealers 506.

A pool 510 may store selected ones of the solutions 508, which may take the form of respective model M instances. The solutions 508 may be selected from the quantum annealer 506 based on their suitability for a particular problem to be solved by the edge devices 504a, 504b, and 504c. Finally, the example architecture 500 may comprise a set of training data D 512, which may be obtained from the edge devices 504a, 504b, and 504c, and/or other sources.

With continued reference to the example architecture 500, an embodiment may define a training dataset based on historical data D 512 obtained by all edge devices 504a, 504b, and 504c, of a network. In this setting, each edge device 504a, 504b, and 504c, may perform predictions using respective BNNs, which may take the form of model M instances deployed at the edge devices 504a, 504b, and 504c, on test data incoming to the edge device 504a, 504b, and 504c. The test data may be provided at the direction of the orchestrator 502.

As an example, edge devices for pathfinding in warehouses need to perform predictions to complete their movements between two checkpoints. Thus, the historical telemetry data needed to perform these predictions may be used to populate D 512.

Given that data drift, or other model performance degradations, may occur over time, as may be determined by evaluating edge telemetry from the edge devices 504a, 504b, and 504c, a selected model Mₐ, which may be deployed at the edge devices 504a, 504b, and 504c, may have its performance degraded, requiring that a suitable model M_{b} from the pool 510 of models be used to replace Mₐ. The gathering and evaluation of the telemetry may be performed by the orchestrator 502. As well, the orchestrator 502 may determine, based on the telemetry evaluation, which model to pull from the pool 510 and deploy to the edge devices 504a, 504b, and 504c. In an embodiment, model performance may be evaluated in terms of data drift, or model overfit/underfit. That is, model performance may be considered in terms of an extent to which, if any, the model operates to mitigate problems such as data drift, and/or an extent to which model perform reflects overfit/underfit of the model to a set of data.

### C. Example Methods

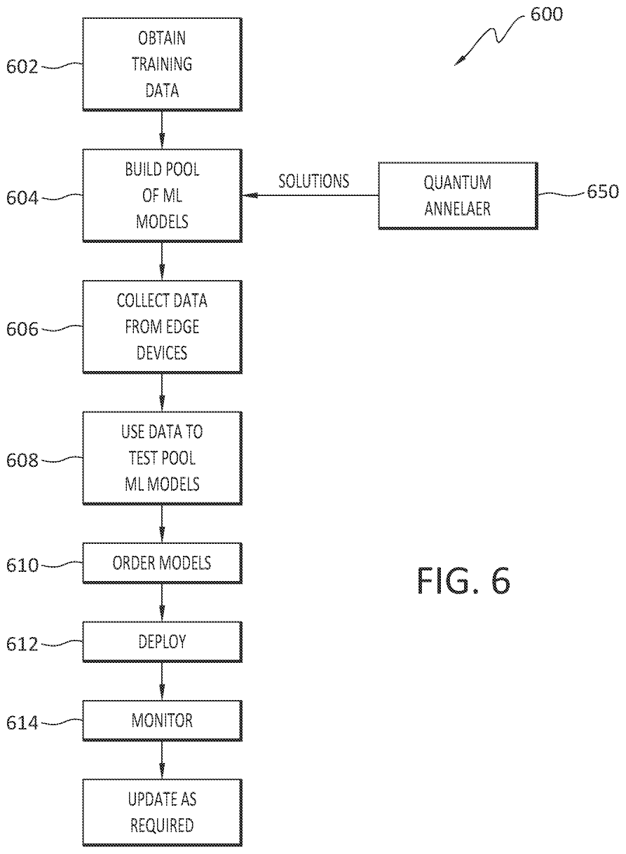

It is noted with respect to the disclosed methods, including the example method of FIG. 6, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 6, and continued attention to the example architecture of FIG. 5, a method according to one embodiment is denoted at 600. In one example embodiment, part or all of the method 600 may be performed by and/or at the direction of, an orchestrator. No particular embodiment of the method is required to be performed by any particular entity, or group of entities, however.

The example method 600 may begin with obtaining 602 a representative training set D based on historical data is determined. In an embodiment, this historical data can come from the solution of the problem that the edge devices are to solve. Next, a pool P of ML models may be built 604 by sampling solutions, that is, various ML models, from a quantum annealer 650. For each edge device eᵢ, collect data 606 and test 608 that data against a measure of interest, such as accuracy for example, of all the ML models LMᵢ in the pool P.

Based on the testing 608, the models LMᵢ may then be ordered 610 according to their performance with respect to the measure(s) of interest. In an embodiment, the models may be ordered, for example, from most accurate to least accurate. After the ordering 610, respective instances of the best performing model may then be deployed 612 to the edge devices.

When the model M instances have been deployed 612, the performance of those instances may be monitored 614, such as by an orchestrator. The monitoring 614 may comprise receiving telemetry from each of the edge devices relating to the performance of the deployed model M instances. If the monitoring 614 reveals that the deployed model performance Mᵢ drops below a minimum threshold, one or more of the edge devices, and/or the orchestrator, may signal a request for model replacement at the edge devices. In this case, an adequate amount of the most recent test data submitted to Mᵢ is used to test every model of LMᵢ, including Mᵢ. The best model is deployed on the edge devices. The orchestrator may include a policy for updating 616 the training D, retraining all models of the pool P, and deploying the updated retrained models, when the monitoring 614 reveals a degradation in model performance at one or more of the edge nodes.

### D. Further Discussion

As made clear in this disclosure, an example embodiment may comprise a hybrid solution based on the use of quantum annealers for edge embodiments formed on classical or quantum computing. An embodiment may implement machine learning model selection based on performance measures. An embodiment may implement performance monitoring and model replacement, based on one or more performance-related measures. By way of contrast, there is presently no known approach that employs the training of machine learning models by sampling solutions from quantum annealers and the deployment of these solutions, that is, models, in edge environment.

### E. Further Example Embodiments

Following are some further example embodiments of the invention. These are presented only by way of example and are not intended to limit the scope of the invention in any way.

Embodiment 1. A method, comprising: creating a training data set comprising historical data regarding performance of respective instances of a machine learning (ML) model deployed at edge devices; creating a pool of ML models by sampling solutions from one or more quantum annealers, and each ML model in the pool comprises a respective one of the solutions; selecting data from the training data set; using the data selected from the training data set to test the ML models in the pool with respect to a specified measure of interest; and deploying respective instances of a best-performing ML model from the pool to each of the edge devices.

Embodiment 2. The method as recited in any preceding embodiment, wherein the specified measure of interest is model accuracy.

Embodiment 3. The method as recited in any preceding embodiment, wherein the specified measure of interest indicates an extent, if any, to which the model exhibits overfit or underfit, and/or an extent to which data drift has occurred or is occurring.

Embodiment 4. The method as recited in any preceding embodiment, wherein after the ML models of the pool are tested, the ML models are ranked according to their respective performances with respect to the specified measure of interest.

Embodiment 5. The method as recited in any preceding embodiment, wherein the solutions were generated by the one or more quantum annealers.

Embodiment 6. The method as recited in any preceding embodiment, wherein the solutions comprise respective solutions to a quadratic unconstrained binary optimization problem.

Embodiment 7. The method as recited in any preceding embodiment, wherein performance of the respective instances of the best-performing ML model is monitored.

Embodiment 8. The method as recited in any preceding embodiment, wherein the instances of the best-performing ML model are replaced with instances of another of the ML models in the pool when one or more of the instances of the best-performing ML model fail to meet the specified measure of interest.

Embodiment 9. The method as recited in any preceding embodiment, wherein when one or more of the instances of the best-performing ML model fail to meet the specified measure of interest, the ML models in the pool are retrained.

Embodiment 10. The method as recited in any preceding embodiment, wherein the instances of the best-performing ML model deployed at the edge devices each comprise a binary neural network.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

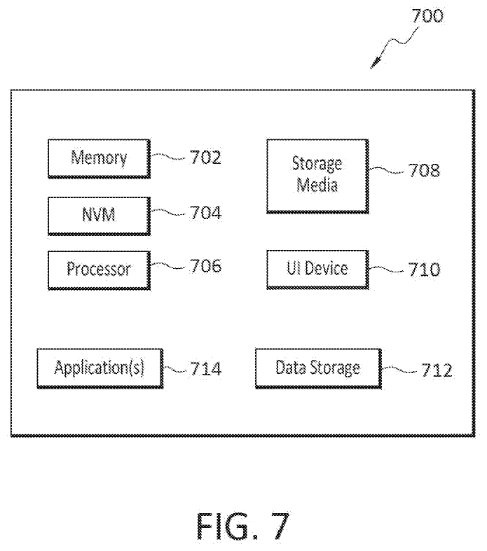

With reference briefly now to FIG. 7, any one or more of the entities disclosed, or implied, by FIGS. 1-6, and/or elsewhere herein, may take the form of, or include, or be implemented on, or hosted by, a physical or quantum computing device, one example of which is denoted at 700. As well, where any of the aforementioned elements comprise or consist of a virtual machine (VM), that VM may constitute a virtualization of any combination of the physical components disclosed in FIG. 7. An embodiment of the computing device 700, or another computing device, may comprise quantum hardware, classical computing hardware, or a combination of quantum and classical computing hardware. By way of example, one embodiment may employ an annealer which may comprise, or consist of, classical computing components such as memory and processors for example. One embodiment may employ an annealer that comprises, or consists, of a quantum annealer. An annealer according to one embodiment may be a digital annealer, or a simulated annealer. No particular type or configuration of annealer is required in any embodiment however. In one embodiment, an explainer may comprise, or consist of, classical computing components.

In the example of FIG. 7, the physical computing device 700, which may take the form of an orchestrator in one embodiment, includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
creating a training data set comprising historical data regarding performance of respective instances of a machine learning (ML) model deployed at edge devices;
creating a pool of ML models by sampling solutions from one or more quantum annealers, and each ML model in the pool comprises a respective one of the solutions;
selecting data from the training data set;
using the data selected from the training data set to test the ML models in the pool with respect to a specified measure of interest; and
deploying respective instances of a best-performing ML model from the pool to each of the edge devices.

2. The method as recited in claim 1, wherein the specified measure of interest is model accuracy.

3. The method as recited in claim 1, wherein the specified measure of interest indicates an extent, if any, to which the model exhibits overfit or underfit, and/or an extent to which data drift has occurred or is occurring.

4. The method as recited in claim 1, wherein after the ML models of the pool are tested, the ML models are ranked according to their respective performances with respect to the specified measure of interest.

5. The method as recited in claim 1, wherein the solutions were generated by the one or more quantum annealers.

6. The method as recited in claim 1, wherein the solutions comprise respective solutions to a quadratic unconstrained binary optimization problem.

7. The method as recited in claim 1, wherein performance of the respective instances of the best-performing ML model is monitored.

8. The method as recited in claim 1, wherein the instances of the best-performing ML model are replaced with instances of another of the ML models in the pool when one or more of the instances of the best-performing ML model fail to meet the specified measure of interest.

9. The method as recited in claim 1, wherein when one or more of the instances of the best-performing ML model fail to meet the specified measure of interest, the ML models in the pool are retrained.

10. The method as recited in claim 1, wherein the instances of the best-performing ML model deployed at the edge devices each comprise a binary neural network.

11. A non-transitory storage medium having stored therein instructions that are executable by one or more hardware processors to perform operations comprising:
creating a training data set comprising historical data regarding performance of respective instances of a machine learning (ML) model deployed at edge devices;
creating a pool of ML models by sampling solutions from one or more quantum annealers, and each ML model in the pool comprises a respective one of the solutions;
selecting data from the training data set;
using the data selected from the training data set to test the ML models in the pool with respect to a specified measure of interest; and
deploying respective instances of a best-performing ML model from the pool to each of the edge devices.

12. The non-transitory storage medium as recited in claim 11, wherein the specified measure of interest is model accuracy.

13. The non-transitory storage medium as recited in claim 11, wherein the specified measure of interest indicates an extent, if any, to which the model exhibits overfit or underfit, and/or an extent to which data drift has occurred or is occurring.

14. The non-transitory storage medium as recited in claim 11, wherein after the ML models of the pool are tested, the ML models are ranked according to their respective performances with respect to the specified measure of interest.

15. The non-transitory storage medium as recited in claim 11, wherein the solutions were generated by the one or more quantum annealers.

16. The non-transitory storage medium as recited in claim 11, wherein the solutions comprise respective solutions to a quadratic unconstrained binary optimization problem.

17. The non-transitory storage medium as recited in claim 11, wherein performance of the respective instances of the best-performing ML model is monitored.

18. The non-transitory storage medium as recited in claim 11, wherein the instances of the best-performing ML model are replaced with instances of another of the ML models in the pool when one or more of the instances of the best-performing ML model fail to meet the specified measure of interest.

19. The non-transitory storage medium as recited in claim 11, wherein when one or more of the instances of the best-performing ML model fail to meet the specified measure of interest, the ML models in the pool are retrained.

20. The non-transitory storage medium as recited in claim 11, wherein the instances of the best-performing ML model deployed at the edge devices each comprise a binary neural network.
